(19) United States
(12) Patent Application Publication
(10) Pub. No.: US 2025/0272965 A1
(43) Pub. Date: Aug. 28, 2025

(54) LEVERAGING ADAPTERS FOR PARAMETER EFFICIENT TRANSFORMER MODELS

(71) Applicant: QUALCOMM Incorporated, San Diego, CA (US)

(72) Inventors: Kyuhong SHIM, Seoul (KR); Jinkyu LEE, Seoul (KR); Hyunjae KIM, Seoul (KR); Kyu Woong HWANG, Daejeon (KR)

(21) Appl. No.: 18/671,847

(22) Filed: May 22, 2024

Related U.S. Application Data
(60) Provisional application No. 63/558,535, filed on Feb. 27, 2024.

(51) Int. Cl. G06V 10/82

(52) U.S. Cl. CPC G06V 10/82

(57) ABSTRACT

Systems and techniques are described herein for executing a machine learning model. For instance, a process can include: receiving input data; processing the input data using a first machine learning (ML) block to generate intermediate data, the first ML block including a first set of parameters; processing the intermediate data using a second ML block to generate processed data, the second ML block including a second set of parameters matching the first set of parameters; and outputting the processed data.

### CROSS-REFERENCE TO RELATED APPLICATIONS

This application claims the benefit of U.S. Provisional Patent Application No. 63/558,535, filed Feb. 27, 2024, which is hereby incorporated by reference, in its entirety and for all purposes.

### FIELD

The present disclosure generally relates to machine learning (ML) models. For example, aspects of the present disclosure are related to systems and techniques for leveraging adapters for parameter efficient transformer models.

### BACKGROUND

Increasingly, artificial intelligence/machine learning (AI/ML) models are being used to perform a wide variety of operations, such as speech recognition, generating/predicting text, translation, process and/or create visual content, and so forth. For example, an automatic speech recognition (ASR) model may be used to listen for keywords, provide real-time transcription, and so forth. Similarly, a large language model (LLM) may be used to perform natural language processing tasks, such as generating, predicting, translating, etc. text, and visual language models (VLMs) may learn to recognize and classify visual elements, such as objects, scenes, styles and so forth.

In some cases, many ML models, such as the aforementioned ASR models, LLMs, VLMs, may be implemented using neural networks (NN) and/or deep learning (DL) networks using a transformer architecture. In some cases, transformer-based ML models may include feed-forward blocks along with other ML blocks. A transformer-based ML model may use an encoder to tokenize inputs, a number of layers to learn relationships between the tokens, and then a decoder to generate predictions using the tokens.

Generally, each feed-forward block of a transformer-based architecture may use a separate set of parameters (e.g., wights) to perform the operations of the feed-forward block. Thus, a set of parameters (e.g., for a feed-forward block) may be used once for a single inference pass. This tends to lead to rapidly increasing model sizes as a number of feed-forward blocks, and hence parameters, are increased. For example, an ASR model may include over a billion parameters. Increased model sizes tend to result in decreased performance of ML models, along with increased storage space, throughput, memory consumption, etc. Thus, techniques for parameter efficiency, that is achieving comparable performance using fewer parameters, may be useful.

### SUMMARY

The following presents a simplified summary relating to one or more aspects disclosed herein. Thus, the following summary should not be considered an extensive overview relating to all contemplated aspects, nor should the following summary be considered to identify key or critical elements relating to all contemplated aspects or to delineate the scope associated with any particular aspect. Accordingly, the following summary presents certain concepts relating to one or more aspects relating to the mechanisms disclosed herein in a simplified form to precede the detailed description presented below.

Systems and techniques are described for herein for leveraging adapters for parameter efficient transformer models. In one illustrative example, an apparatus for executing a machine learning model is provided. The apparatus includes: one or more memories; and one or more processors coupled to the one or more memories. The one or more processors are configured to: receive input data; process the input data using a first machine learning (ML) block to generate intermediate data, the first ML block including a first set of parameters; process the intermediate data using a second ML block to generate processed data, the second ML block including a second set of parameters matching the first set of parameters; and output the processed data.

As another example, a method for executing a machine learning model is provided. The method includes: receiving input data; processing the input data using a first machine learning (ML) block to generate intermediate data, the first ML block including a first set of parameters; processing the intermediate data using a second ML block to generate processed data, the second ML block including a second set of parameters matching the first set of parameters; and outputting the processed data.

In another example, a non-transitory computer-readable medium having stored thereon instructions is provided. The instructions, when executed by at least one processor, cause the at least one processor to: receive input data; process the input data using a first machine learning (ML) block to generate intermediate data, the first ML block including a first set of parameters; process the intermediate data using a second ML block to generate processed data, the second ML block including a second set of parameters matching the first set of parameters; and output the processed data.

As another example, an apparatus for executing a machine learning model is provided. The apparatus includes means for receiving input data; means for processing the input data using a first machine learning (ML) block to generate intermediate data, the first ML block including a first set of parameters; means for processing the intermediate data using a second ML block to generate processed data, the second ML block including a second set of parameters matching the first set of parameters; and means for outputting the processed data.

In some aspects, one or more of the apparatuses described herein comprises a mobile device (e.g., a mobile telephone or so-called “smart phone”, a tablet computer, or other type of mobile device), a wearable device, an extended reality device (e.g., a virtual reality (VR) device, an augmented reality (AR) device, or a mixed reality (MR) device), a personal computer, a laptop computer, a video server, a television (e.g., a network-connected television), a vehicle (or a computing device of a vehicle), or other device. In some aspects, the apparatus(es) include at least one camera for capturing one or more images or video frames. For example, the apparatus(es) can include a camera (e.g., an RGB camera) or multiple cameras for capturing one or more images and/or one or more videos including video frames. In some aspects, the apparatus(es) can include a display for displaying one or more images, videos, notifications, or other displayable data. In some aspects, the apparatus(es) can include a transmitter configured to transmit one or more video frame and/or syntax data over a transmission medium to at least one device. In some aspects, the processor includes a neural processing unit (NPU), a central processing unit (CPU), a graphics processing unit (GPU), or other processing device or component.

This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings, and each claim.

The foregoing, together with other features and embodiments, will become more apparent upon referring to the following specification, claims, and accompanying drawings.

### BRIEF DESCRIPTION OF THE DRAWINGS

Illustrative embodiments of the present application are described in detail below with reference to the following figures:

FIG. 1 illustrates an example implementation of a system-on-a-chip (SOC), in accordance with some examples;

FIG. 2 is a block diagram illustrating an example of a deep learning neural network, according to some aspects of the present disclosure;

FIG. 3 is a block diagram illustrating an example of a convolutional neural network (CNN), according to various aspects of the present disclosure;

FIG. 4 is a block diagram illustrating an example of a deep convolutional network, in accordance with aspects of the present disclosure;

FIG. 5A illustrates a transformer block, in accordance with aspects of the present disclosure;

FIG. 5B illustrates a conformer block, in accordance with aspects of the present disclosure;

FIG. 5C illustrates a convnext block, in accordance with aspects of the present disclosure;

FIG. 5D illustrates a feed-forward block, in accordance with aspects of the present disclosure;

FIG. 6 is a block diagram illustrating a machine learning system for leveraging adapters for parameter efficient transformer models, in accordance with aspects of the present disclosure;

FIG. 7 is a flow diagram illustrating a process for executing a machine learning model, in accordance with aspects of the present disclosure;

FIG. 8 illustrates an example computing device architecture of an example computing device which can implement the various techniques described herein.

### DETAILED DESCRIPTION

Certain aspects and embodiments of this disclosure are provided below. Some of these aspects and embodiments may be applied independently and some of them may be applied in combination as would be apparent to those of skill in the art. In the following description, for the purposes of explanation, specific details are set forth in order to provide a thorough understanding of embodiments of the application. However, it will be apparent that various embodiments may be practiced without these specific details. The figures and description are not intended to be restrictive.

The ensuing description provides example embodiments only, and is not intended to limit the scope, applicability, or configuration of the disclosure. Rather, the ensuing description of the example embodiments will provide those skilled in the art with an enabling description for implementing an example embodiment. It should be understood that various changes may be made in the function and arrangement of elements without departing from the spirit and scope of the application as set forth in the appended claims.

Many tasks may be performed using ML models. As ML models become better at performing tasks, ML models can become more complex. As complexity grows, a number of parameters (e.g., weights) in ML models can increase. For example, a LLM such at GPT-4, may include well over a trillion parameters. As the number of parameters increase resource consumption of these ML models may also increase. Thus, techniques for parameter efficiency may be useful.

Systems, apparatuses, electronic devices, methods (also referred to as processes), and computer-readable media (collectively referred to herein as “systems and techniques”) are described for leveraging adapters for parameter efficient transformer models. For example, many ML models may include many version of a same block, such as a feed-forward block, each with their own set of parameters. These parameters may be used a single time, for example, during an inference run. In some cases, certain ML blocks which perform mixing operations, such as convolution, self-attention, etc. may be candidates for parameters reuse. As an example, feed-forward blocks may include multiple convolution operations and may make up a relatively large percentage of parameters in some ML models, making feed-forward blocks a candidate block for parameter reuse. For parameter reuse, a ML block may include a set of parameters and this set of parameters may be the same as (e.g., match) another set of parameters for a second ML block. Data may be processed by the first ML block to generate intermediate data. This intermediate data may then be the basis of data that may be processed by the second ML block (e.g., the intermediate data may be processed by one or more third ML blocks before being processed by the second ML block). In some cases, ML blocks that reuse (e.g., share) parameters may be a same kind of ML block. For example, the ML blocks that reuse parameters may be feed-forward blocks. These feed-forward blocks may be used in a transformer block, conformer block, and/or convnext block. An ML block, or neural network block, may be a collection of multiple deep neural network layers or operations. The block often refers the architecture, structure, or process of how input to the block pass through the block and/or how the inputs are changed by the block. In some cases, the term block and module may be used interchangeably.

In some cases, simply repeating the same block may collapse the feature representation space of the ML model and hurt the expressiveness of the ML model. To avoid this issue, an adapter block may be added to blocks which reuse parameters. The adapter blocks may be specific to a particular ML block which is reusing parameters and certain parameters of the adapter blocks may not be shared across the parameter blocks. For example, the adapter blocks may include one or more linear layers and parameters of these one or more linear layers may not be shared from one adapter block to another adapter block. In some cases, these adapter blocks may be trained along with the rest of the ML model.

Various aspects of the present disclosure will be described with respect to the figures.

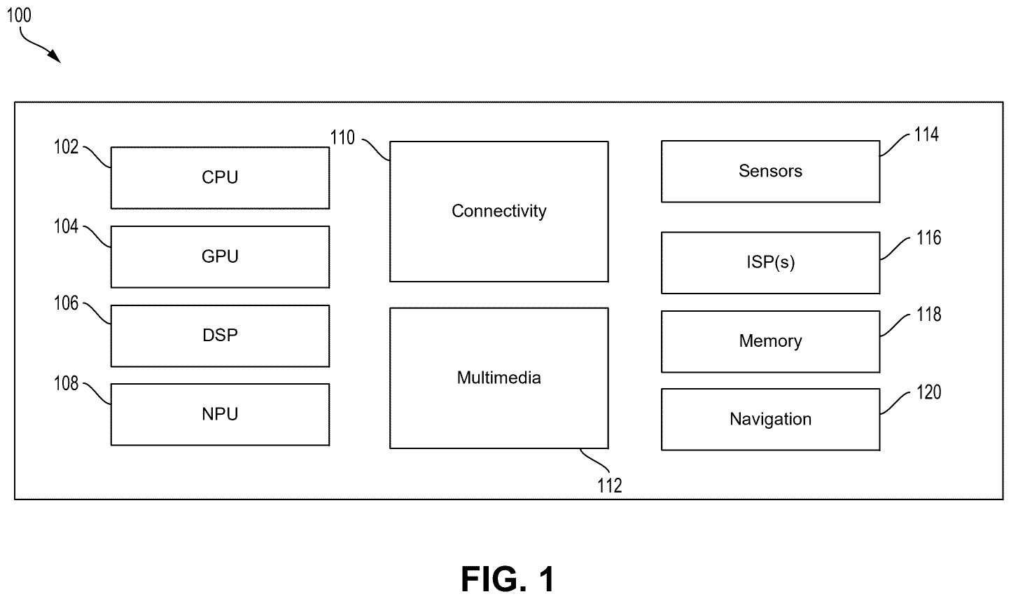

FIG. 1 illustrates an example implementation of a system-on-a-chip (SOC) 100, which may include a central processing unit (CPU) 102 or a multi-core CPU, configured to perform one or more of the functions described herein. Parameters or variables (e.g., neural signals and synaptic weights), system parameters associated with a computational device (e.g., neural network with weights), delays, frequency bin information, task information, among other information may be stored in a memory block associated with a neural processing unit (NPU) 108, in a memory block associated with a CPU 102, in a memory block associated with a graphics processing unit (GPU) 104, in a memory block associated with a digital signal processor (DSP) 106, in a memory block 118, and/or may be distributed across multiple blocks. Instructions executed at the CPU 102 may be loaded from a program memory associated with the CPU 102 or may be loaded from a memory block 118.

The SOC 100 may also include additional processing blocks tailored to specific functions, such as a GPU 104, a DSP 106, a connectivity block 110, which may include fifth generation (5G) connectivity, fourth generation long term evolution (4G LTE) connectivity, Wi-Fi connectivity, USB connectivity, Bluetooth connectivity, and the like, and a multimedia processor 112 that may, for example, detect and recognize gestures. In one implementation, the NPU is implemented in the CPU 102, DSP 106, and/or GPU 104. The SOC 100 may also include a sensor processor 114, image signal processors (ISPs) 116, and/or navigation module 120, which may include a global positioning system.

The SOC 100 may be based on an ARM instruction set. SOC 100 and/or components thereof may be configured to perform segmentation mask extrapolation. For example, the CPU 102, DSP 106, and/or GPU 104 may be configured to perform object detection using a visual language model via latent feature adaptation with synthetic data.

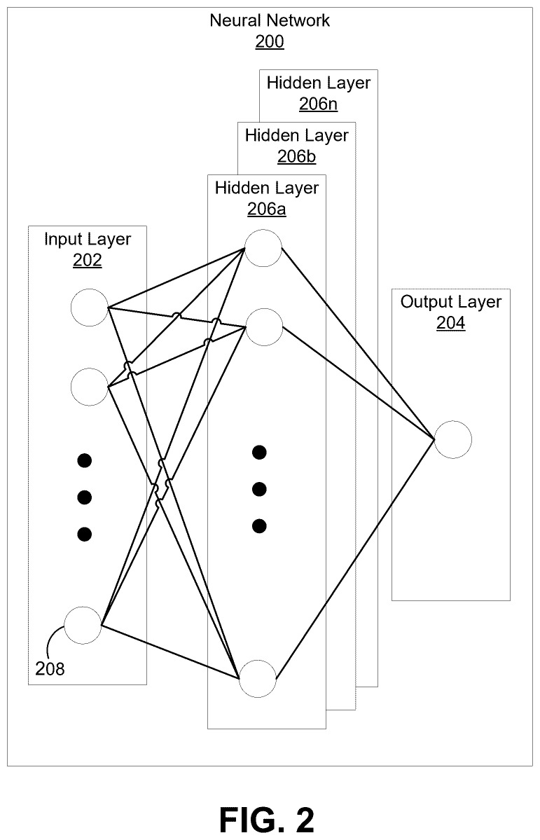

FIG. 2 is an illustrative example of a neural network 200 (e.g., a deep-learning neural network) that can be used to implement machine-learning-based image generation, feature segmentation, implicit-neural-representation generation, rendering, classification, object detection, image recognition (e.g., face recognition, object recognition, scene recognition, etc.), feature extraction, authentication, gaze detection, gaze prediction, and/or automation. The neural network 200 may be run, for example, on one or more processors, such as CPU 102 of FIG. 1, GPU 104 of FIG. 1, DSP 106 of FIG. 1, NPU 108 of FIG. 1, etc.

An input layer 202 includes input data. Neural network 200 includes multiple hidden layers hidden layers 206a, 206b, through 206n. The hidden layers 206a, 206b, through hidden layer 206n include “n” number of hidden layers, where “n” is an integer greater than or equal to one. The number of hidden layers can be made to include as many layers as needed for the given application. Neural network 200 further includes an output layer 204 that provides an output resulting from the processing performed by the hidden layers 206a, 206b, through 206n.

Neural network 200 may be, or may include, a multi-layer neural network of interconnected nodes. Each node can represent a piece of information. Information associated with the nodes is shared among the different layers and each layer retains information as information is processed. In some cases, neural network 200 can include a feed-forward network, in which case there are no feedback connections where outputs of the network are fed back into itself. In some cases, neural network 200 can include a recurrent neural network, which can have loops that allow information to be carried across nodes while reading in input.

Information can be exchanged between nodes through node-to-node interconnections between the various layers. Nodes of input layer 202 can activate a set of nodes in the first hidden layer 206a. For example, as shown, each of the input nodes of input layer 202 is connected to each of the nodes of the first hidden layer 206a. The nodes of first hidden layer 206a can transform the information of each input node by applying activation functions to the input node information. The information derived from the transformation can then be passed to and can activate the nodes of the next hidden layer 206b, which can perform their own designated functions. Example functions include convolutional, up-sampling, data transformation, and/or any other suitable functions. The output of the hidden layer 206b can then activate nodes of the next hidden layer, and so on. The output of the last hidden layer 206n can activate one or more nodes of the output layer 204, at which an output is provided. In some cases, while nodes (e.g., node 208) in neural network 200 are shown as having multiple output lines, a node has a single output and all lines shown as being output from a node represent the same output value.

In some cases, each node or interconnection between nodes can have a weight that is a set of parameters derived from the training of neural network 200. Once neural network 200 is trained, it can be referred to as a trained neural network, which can be used to perform one or more operations. For example, an interconnection between nodes can represent a piece of information learned about the interconnected nodes. The interconnection can have a tunable numeric weight that can be tuned (e.g., based on a training dataset), allowing neural network 200 to be adaptive to inputs and able to learn as more and more data is processed.

Neural network 200 may be pre-trained to process the features from the data in the input layer 202 using the different hidden layers 206a, 206b, through 206n in order to provide the output through the output layer 204. In an example in which neural network 200 is used to identify features in images, neural network 200 can be trained using training data that includes both images and labels, as described above. For instance, training images can be input into the network, with each training image having a label indicating the features in the images (for the feature-segmentation machine-learning system) or a label indicating classes of an activity in each image. In one example using object classification for illustrative purposes, a training image can include an image of a number 2, in which case the label for the image can be [0 0 1 0 0 0 0 0 0 0].

In some cases, neural network 200 can adjust the weights of the nodes using a training process called backpropagation. As noted above, a backpropagation process can include a forward pass, a loss function, a backward pass, and a weight update. The forward pass, loss function, backward pass, and parameter update is performed for one training iteration. The process can be repeated for a certain number of iterations for each set of training images until neural network 200 is trained well enough so that the weights of the layers are accurately tuned.

For the example of identifying objects in images, the forward pass can include passing a training image through neural network 200. The weights are initially randomized before neural network 200 is trained. As an illustrative example, an image can include an array of numbers representing the pixels of the image. Each number in the array can include a value from 0 to 255 describing the pixel intensity at that position in the array. In one example, the array can include a 28×28×3 array of numbers with 28 rows and 28 columns of pixels and 3 color components (such as red, green, and blue, or luma and two chroma components, or the like).

As noted above, for a first training iteration for neural network 200, the output will likely include values that do not give preference to any particular class due to the weights being randomly selected at initialization. For example, if the output is a vector with probabilities that the object includes different classes, the probability value for each of the different classes can be equal or at least very similar (e.g., for ten possible classes, each class can have a probability value of 0.1). With the initial weights, neural network 200 is unable to determine low-level features and thus cannot make an accurate determination of what the classification of the object might be. A loss function can be used to analyze error in the output. Any suitable loss function definition can be used, such as a cross-entropy loss. Another example of a loss function includes the mean squared error (MSE), defined as Eₜₒₜₐₗ=Σ½(target−output)². The loss can be set to be equal to the value of Etotal.

The loss (or error) will be high for the first training images since the actual values will be much different than the predicted output. The goal of training is to minimize the amount of loss so that the predicted output is the same as the training label. Neural network 200 can perform a backward pass by determining which inputs (weights) most contributed to the loss of the network and can adjust the weights so that the loss decreases and is eventually minimized. A derivative of the loss with respect to the weights (denoted as dL/dW, where W are the weights at a particular layer) can be computed to determine the weights that contributed most to the loss of the network. After the derivative is computed, a weight update can be performed by updating all the weights of the filters. For example, the weights can be updated so that they change in the opposite direction of the gradient. The weight update can be denoted as w=wᵢ−ηdL/dW, where w denotes a weight, wi denotes the initial weight, and f denotes a learning rate. The learning rate can be set to any suitable value, with a high learning rate including larger weight updates and a lower value indicating smaller weight updates.

Neural network 200 can include any suitable deep network. One example includes a convolutional neural network (CNN), which includes an input layer and an output layer, with multiple hidden layers between the input and out layers. The hidden layers of a CNN include a series of convolutional, nonlinear, pooling (for downsampling), and fully connected layers. Neural network 200 can include any other deep network other than a CNN, such as an autoencoder, a deep belief nets (DBNs), a Recurrent Neural Networks (RNNs), among others.

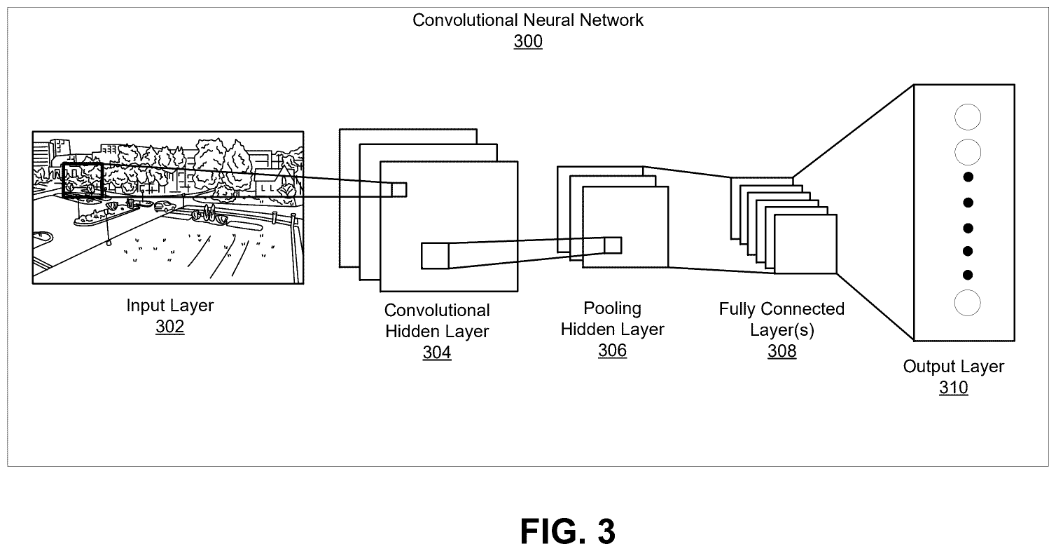

FIG. 3 is an illustrative example of a convolutional neural network (CNN) 300. The input layer 302 of the CNN 300 includes data representing an image or frame. For example, the data can include an array of numbers representing the pixels of the image, with each number in the array including a value from 0 to 255 describing the pixel intensity at that position in the array. Using the previous example from above, the array can include a 28×28×3 array of numbers with 28 rows and 28 columns of pixels and 3 color components (e.g., red, green, and blue, or luma and two chroma components, or the like). The image can be passed through a convolutional hidden layer 304, an optional non-linear activation layer, a pooling hidden layer 306, and fully connected layer 308 (which fully connected layer 308 can be hidden) to get an output at the output layer 310. While only one of each hidden layer is shown in FIG. 3, one of ordinary skill will appreciate that multiple convolutional hidden layers, non-linear layers, pooling hidden layers, and/or fully connected layers can be included in the CNN 300. As previously described, the output can indicate a single class of an object or can include a probability of classes that best describe the object in the image.

The first layer of the CNN 300 can be the convolutional hidden layer 304. The convolutional hidden layer 304 can analyze image data of the input layer 302. Each node of the convolutional hidden layer 304 is connected to a region of nodes (pixels) of the input image called a receptive field. The convolutional hidden layer 304 can be considered as one or more filters (each filter corresponding to a different activation or feature map), with each convolutional iteration of a filter being a node or neuron of the convolutional hidden layer 304. For example, the region of the input image that a filter covers at each convolutional iteration would be the receptive field for the filter. In one illustrative example, if the input image includes a 28×28 array, and each filter (and corresponding receptive field) is a 5×5 array, then there will be 24×24 nodes in the convolutional hidden layer 304. Each connection between a node and a receptive field for that node learns a weight and, in some cases, an overall bias such that each node learns to analyze its particular local receptive field in the input image. Each node of the convolutional hidden layer 304 will have the same weights and bias (called a shared weight and a shared bias). For example, the filter has an array of weights (numbers) and the same depth as the input. A filter will have a depth of 3 for an image frame example (according to three color components of the input image). An illustrative example size of the filter array is 5×5×3, corresponding to a size of the receptive field of a node.

The convolutional nature of the convolutional hidden layer 304 is due to each node of the convolutional layer being applied to its corresponding receptive field. For example, a filter of the convolutional hidden layer 304 can begin in the top-left corner of the input image array and can convolve around the input image. As noted above, each convolutional iteration of the filter can be considered a node or neuron of the convolutional hidden layer 304. At each convolutional iteration, the values of the filter are multiplied with a corresponding number of the original pixel values of the image (e.g., the 5×5 filter array is multiplied by a 5×5 array of input pixel values at the top-left corner of the input image array). The multiplications from each convolutional iteration can be summed together to obtain a total sum for that iteration or node. The process is next continued at a next location in the input image according to the receptive field of a next node in the convolutional hidden layer 304. For example, a filter can be moved by a step amount (referred to as a stride) to the next receptive field. The stride can be set to 1 or any other suitable amount. For example, if the stride is set to 1, the filter will be moved to the right by 1 pixel at each convolutional iteration. Processing the filter at each unique location of the input volume produces a number representing the filter results for that location, resulting in a total sum value being determined for each node of the convolutional hidden layer 304.

The mapping from the input layer to the convolutional hidden layer 304 is referred to as an activation map (or feature map). The activation map includes a value for each node representing the filter results at each location of the input volume. The activation map can include an array that includes the various total sum values resulting from each iteration of the filter on the input volume. For example, the activation map will include a 24×24 array if a 5×5 filter is applied to each pixel (a stride of 1) of a 28×28 input image. The convolutional hidden layer 304 can include several activation maps in order to identify multiple features in an image. The example shown in FIG. 3 includes three activation maps. Using three activation maps, the convolutional hidden layer 304 can detect three different kinds of features, with each feature being detectable across the entire image.

In some examples, a non-linear hidden layer can be applied after the convolutional hidden layer 304. The non-linear layer can be used to introduce non-linearity to a system that has been computing linear operations. One illustrative example of a non-linear layer is a rectified linear unit (ReLU) layer. A ReLU layer can apply the function f(x)=max(0, x) to all of the values in the input volume, which changes all the negative activations to 0. The ReLU can thus increase the non-linear properties of the CNN 300 without affecting the receptive fields of the convolutional hidden layer 304.

The pooling hidden layer 306 can be applied after the convolutional hidden layer 304 (and after the non-linear hidden layer when used). The pooling hidden layer 306 is used to simplify the information in the output from the convolutional hidden layer 304. For example, the pooling hidden layer 306 can take each activation map output from the convolutional hidden layer 304 and generates a condensed activation map (or feature map) using a pooling function. Max-pooling is one example of a function performed by a pooling hidden layer. Other forms of pooling functions be used by the pooling hidden layer 306, such as average pooling, L2-norm pooling, or other suitable pooling functions. A pooling function (e.g., a max-pooling filter, an L2-norm filter, or other suitable pooling filter) is applied to each activation map included in the convolutional hidden layer 304. In the example shown in FIG. 3, three pooling filters are used for the three activation maps in the convolutional hidden layer 304.

In some examples, max-pooling can be used by applying a max-pooling filter (e.g., having a size of 2×2) with a stride (e.g., equal to a dimension of the filter, such as a stride of 2) to an activation map output from the convolutional hidden layer 304. The output from a max-pooling filter includes the maximum number in every sub-region that the filter convolves around. Using a 2×2 filter as an example, each unit in the pooling layer can summarize a region of 2×2 nodes in the previous layer (with each node being a value in the activation map). For example, four values (nodes) in an activation map will be analyzed by a 2×2 max-pooling filter at each iteration of the filter, with the maximum value from the four values being output as the “max” value. If such a max-pooling filter is applied to an activation filter from the convolutional hidden layer 304 having a dimension of 24×24 nodes, the output from the pooling hidden layer 306 will be an array of 12×12 nodes.

In some examples, an L2-norm pooling filter could also be used. The L2-norm pooling filter includes computing the square root of the sum of the squares of the values in the 2×2 region (or other suitable region) of an activation map (instead of computing the maximum values as is done in max-pooling) and using the computed values as an output.

The pooling function (e.g., max-pooling, L2-norm pooling, or other pooling function) determines whether a given feature is found anywhere in a region of the image and discards the exact positional information. This can be done without affecting results of the feature detection because, once a feature has been found, the exact location of the feature is not as important as its approximate location relative to other features. Max-pooling (as well as other pooling methods) offer the benefit that there are many fewer pooled features, thus reducing the number of parameters needed in later layers of the CNN 300.

The final layer of connections in the network is a fully-connected layer that connects every node from the pooling hidden layer 306 to every one of the output nodes in the output layer 310. Using the example above, the input layer includes 28×28 nodes encoding the pixel intensities of the input image, the convolutional hidden layer 304 includes 3×24×24 hidden feature nodes based on application of a 5×5 local receptive field (for the filters) to three activation maps, and the pooling hidden layer 306 includes a layer of 3×12×12 hidden feature nodes based on application of max-pooling filter to 2×2 regions across each of the three feature maps. Extending this example, the output layer 310 can include ten output nodes. In such an example, every node of the 3×12×12 pooling hidden layer 306 is connected to every node of the output layer 310.

The fully connected layer 308 can obtain the output of the previous pooling hidden layer 306 (which should represent the activation maps of high-level features) and determines the features that most correlate to a particular class. For example, the fully connected layer 308 can determine the high-level features that most strongly correlate to a particular class and can include weights (nodes) for the high-level features. A product can be computed between the weights of the fully connected layer 308 and the pooling hidden layer 306 to obtain probabilities for the different classes. For example, if the CNN 300 is being used to predict that an object in an image is a person, high values will be present in the activation maps that represent high-level features of people (e.g., two legs are present, a face is present at the top of the object, two eyes are present at the top left and top right of the face, a nose is present in the middle of the face, a mouth is present at the bottom of the face, and/or other features common for a person).

In some examples, the output from the output layer 310 can include an M-dimensional vector (in the prior example, M=10). M indicates the number of classes that the CNN 300 has to choose from when classifying the object in the image. Other example outputs can also be provided. Each number in the M-dimensional vector can represent the probability the object is of a certain class. In one illustrative example, if a 10-dimensional output vector represents ten different classes of objects is [0 0 0.05 0.8 0 0.15 0 0 0 0], the vector indicates that there is a 5% probability that the image is the third class of object (e.g., a dog), an 80% probability that the image is the fourth class of object (e.g., a human), and a 15% probability that the image is the sixth class of object (e.g., a kangaroo). The probability for a class can be considered a confidence level that the object is part of that class.

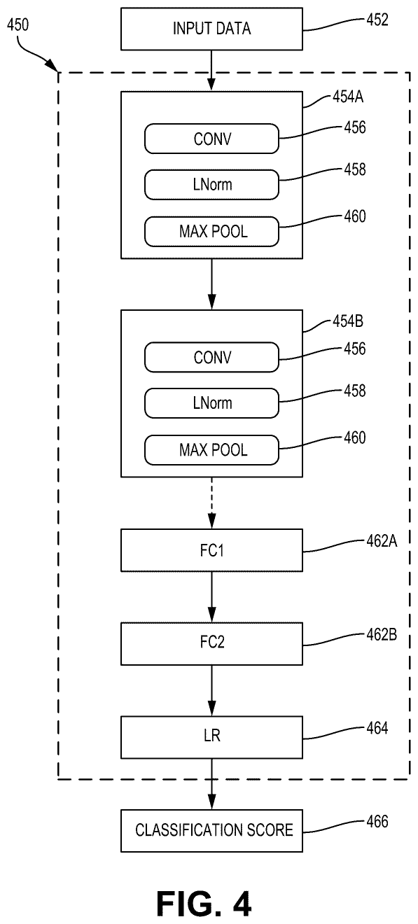

FIG. 4 is a block diagram illustrating an example of a deep convolutional network 450. The deep convolutional network 450 may include multiple different types of layers based on connectivity and weight sharing. As shown in FIG. 4, the deep convolutional network 450 includes the convolution blocks 454A, 454B. Each of the convolution blocks 454A, 454B may be configured with a convolution layer (CONV) 456, a normalization layer (LNorm) 458, and a max pooling layer (MAX POOL) 460. Of note, the layers illustrated with respect to convolution blocks 454A and 454B are examples of layers that may be included in a convolution layer and are not intended to be limiting and other types of layers may be included in any order.

The convolution layers 456 may include one or more convolutional filters, which may be applied to the input data 452 to generate a feature map. Although only two convolution blocks 454A, 454B are shown, the present disclosure is not so limiting, and instead, any number of convolution blocks (e.g., convolution blocks 454A, 454B) may be included in the deep convolutional network 450 according to design preference. The normalization layer 458 may normalize the output of the convolution filters. For example, the normalization layer 458 may provide whitening or lateral inhibition. The max pooling layer 460 may provide down sampling aggregation over space for local invariance and dimensionality reduction.

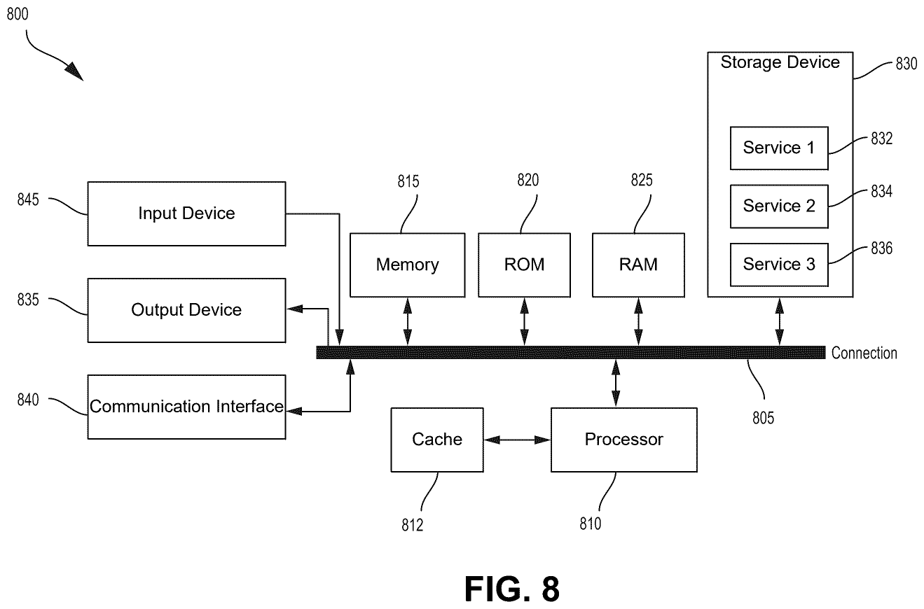

The parallel filter banks, for example, of a deep convolutional network may be loaded on a processor such as a CPU or GPU, or any other type of processor 810 discussed with respect to the computing device architecture 800 of FIG. 8 to achieve high performance and low power consumption. In alternative aspects, the parallel filter banks may be loaded on a DSP or an ISP of the computing device architecture 800 of FIG. 8. In addition, the deep convolutional network 450 may access other processing blocks that may be present on the computing device architecture 800 of FIG. 8, such as sensor processor and navigation module, dedicated, respectively, to sensors and navigation.

The deep convolutional network 450 may also include one or more fully connected layers, such as layer 462A (labeled “FC1”) and layer 462B (labeled “FC2”). The deep convolutional network 450 may further include a logistic regression (LR) layer 464. Between each layer 456, 458, 460, 462A, 462B, 464 of the deep convolutional network 450 are weights (not shown) that are to be updated. The output of each of the layers (e.g., 456, 458, 460, 462A, 462B, 464) may serve as an input of a succeeding one of the layers (e.g., 456, 458, 460, 462A, 462B, 464) in the deep convolutional network 450 to learn hierarchical feature representations from input data 452 (e.g., images, audio, video, sensor data and/or other input data) supplied at the first of the convolution blocks 454A. The output of the deep convolutional network 450 is a classification score 466 for the input data 452. The classification score 466 may be a set of probabilities, where each probability is the probability of the input data including a feature from a set of features.

In some cases, one or more convolutional networks, such as a DCN, may be incorporated into more complex ML networks. As an example, as indicated above, the deep convolutional network 450 may output probabilities that an input data, such as an image, includes certain features. The deep convolutional network 450 may then be modified to extract (e.g., output) certain features. Additionally, DCNs may be added to extract other features as well. This set of DCNs may function as feature extractors to identify features in an image. In some cases, feature extractors may be used as a backbone for additionally ML network components to perform further operations, such as image segmentation.

In some cases, transformer blocks, and variants of transformer blocks, such as conformer blocks and convnext blocks, may be used for a variety of applications where complex, non-linear relationships may be learned, such as for language-based tasks. For example, transformer blocks may be used in large language models. A transformer block may be used in a ML model that can learn context about features to try to detect patterns in data to determine how certain portions of the data may influence other portions. Transformer blocks may be inserted into other ML models, such as DCN 450 of FIG. 4, CNN 300 of FIG. 3, neural network 200 of FIG. 2, etc.

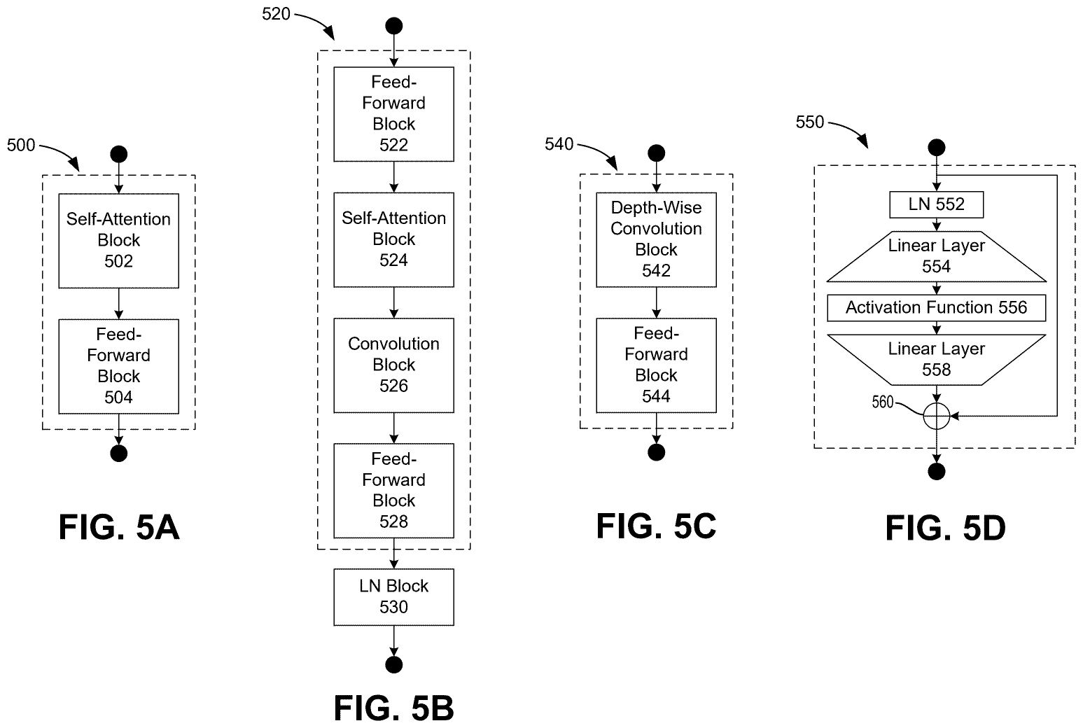

FIG. 5A illustrates a transformer block 500, in accordance with aspects of the present disclosure. In some cases, a ML model may include one or more transformer blocks, such as transformer block 500. The transformer block 500 may include a self-attention block 502 and a feed-forward block 504. Data may be input into the self-attention block 502 to generate intermediate data. In some cases, a self-attention block, such as self-attention block 502, may enhance input information content by contextualizing the information, for example, to capture dependencies, relationships, etc. The intermediate data output by the self-attention block 502 may be passed to the feed forward block 504. In some cases, a feed forward block, such as feed forward block 504, may help pass information forward through a ML network, such as by taking the output of a self-attention block 502 and passing the output forward. In some cases, other blocks may be included in the transformer block 500 and multiple transformer blocks may be stacked/repeated.

FIG. 5B illustrates a conformer block 520, in accordance with aspects of the present disclosure. In some cases, a ML model may include one or more conformer blocks, such as conformer block 520. Conformer blocks may be used, for example, in speech related ML models. The conformer block 520 may include a feed forward block 522, a self-attention block 524, a convolution block 526, and a second feed forward block 528. In some cases, the conformer block 520 may be followed by a layer norm (LN) block 530.

Input data to the conformer block 520 may be input to the feed forward block 522 for processing to generate intermediate data. The intermediate data may be passed to the self-attention block 524. The self-attention block 524 may generate intermediate data that may be input to the convolution block 526 for processing. The convolution block 526 may output intermediate data to the second feed-forward block 528 for processing. Intermediate data output from the conformer block 520 may be passed into to the LN block 530 for additional processing. In some cases, a LN block, such as LN block 530, may normalize data input to the LN block, for example, based on a mean and/or variance of the data input. In some cases, other blocks may be included in the conformer block 520 and multiple conformer blocks may be stacked/repeated.

FIG. 5C illustrates a convnext block 540, in accordance with aspects of the present disclosure. In some cases, a ML model may include one or more convnext blocks, such as convnext block 540. Convnext blocks may be used, for example, in vision related ML models. The convnext block 540 may include a depth-wise convolution block 542 and a feed-forward block 544. Data may be input to the depth-wise convolution block 542, which outputs to the feed-forward block 544. In some cases, other blocks may be included in the convnext block 540 and multiple convnext blocks may be stacked/repeated.

In some cases, while the exact block composition of the transformer block 500, conformer block 520, and convnext block 540 may vary based on the specific application of the block, a feed-forward block (e.g., feed forward blocks 504, 538, and 544) may still be used.

FIG. 5D illustrates a feed-forward block 550, in accordance with aspects of the present disclosure. The feed-forward block 550 includes a layer normalization (LN) layer 552, which may normalize data input to the LN layer 552 based on a mean and variance of the data input. The output of the LN layer 552 may be passed to a linear layer 554 (e.g., fully connected layer) that may perform a matrix reprojection from a smaller number of input dimensions to a larger number of output dimensions. The matrix reprojection may be performed based on a set of reprojection matrix parameters (e.g., weights). Output of the linear layer 554 may be input to an activation function 556, such as a rectified linear unit (ReLU) operation, gaussian error linear unit (GELU), or other non-linear function. Output of the activation function 556 may be input to another linear layer 558 which performs a matrix reprojection from a larger number of input dimensions to a smaller number of output dimensions based on another set of reprojection matrix parameters. Output of the linear layer 558 may be summed 560 with the input data for output.

As shown in FIG. 5A-5C, transformer blocks and variants of transformer blocks may all include feed-forward blocks (e.g., feed-forward blocks 504, 522, 528, 544). In some cases, these feed-forward blocks may encompass a relatively large percentage of a total number of parameters of such blocks (e.g., feed-forward blocks may include a majority of the parameters in transformer/transformer variant blocks). In some cases, parameters of two or more blocks, such as the feed-forward blocks, of a ML model may be re-used (e.g., shared). In some cases, it may be simpler to re-use parameters across multiple, similar, blocks (e.g., across a set of feed-forward blocks). As feed-forward blocks may be included in transformers and variants of transformers, parameters of feed-forward blocks may be reused to help achieve better parameter efficiency. While discussed in the context of feed-forward blocks, it should be understood that the techniques for parameter reuse discussed herein may be applied to other neural network blocks/modules as well.

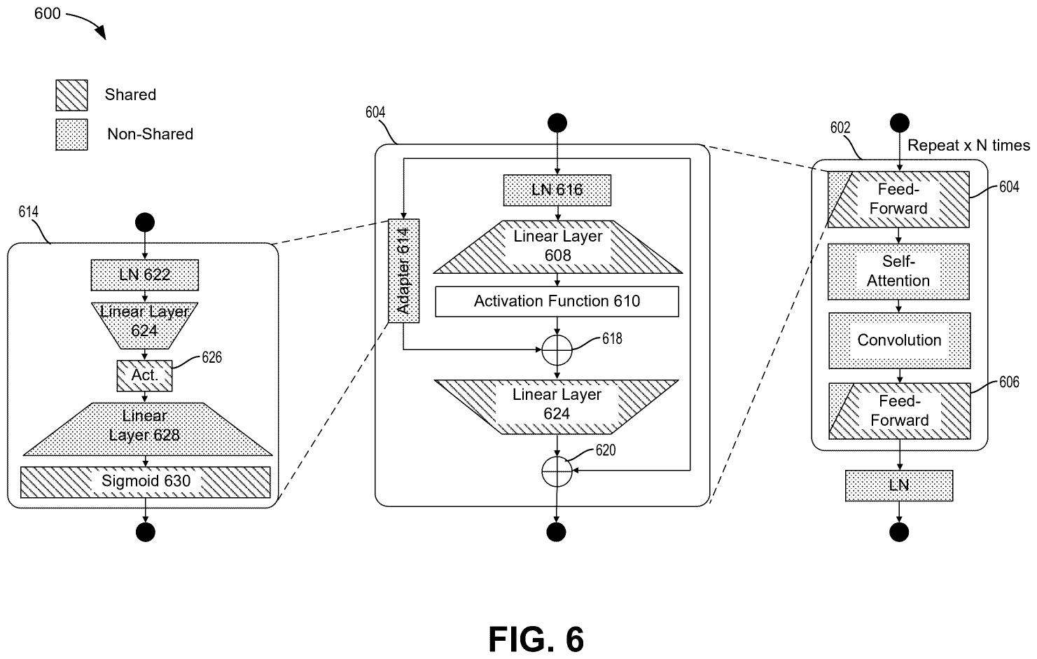

FIG. 6 is a block diagram illustrating a machine learning system 600 for leveraging adapters for parameter efficient transformer models, in accordance with aspects of the present disclosure. FIG. 6 includes a conformer block 602 which is similar to conformer block 520 of FIG. 5B. The conformer block 602 includes a first feed-forward block 604 and a second feed-forward block 606. The first feed-forward block 604 and the second feed-forward block 606 may reuse parameters (e.g., configured to support parameter reuse).

In some cases, a block may be configured to allow parameter reuse using an adapter block 614. For example, a feed-forward block, such as feed-forward block 550 of FIG. 5D, feed-forward block 604 of FIG. 6, etc., may include a first linear layer 608, an activation function 610, and a second linear layer 612. The feed-forward block 604 may be modified to allow parameter reuse by adding an adapter block 614 and an LN layer 616. In a feed-forward block configured for parameter reuse, such as the first feed-forward block 604 and the second feed-forward block 606, input data may be input to the LN layer 616 and adapter block 614. Output of the LN layer 616 may be input to the first linear layer 608. Output of the first linear layer 608 may be passed to the activation function 610. Output of the activation function 610 (e.g., intermediate features) may be multiplied 618 with output from the adapter block 614 and input to the second linear layer 612. In some cases, multiplying the intermediate features with the output from the adapter block 614 dynamically rescales the intermediate features, allowing for different feed-forward blocks to perform differently, despite shared parameters. Output of the second linear layer 612 may be summed 620 with the input data for output.

In some cases, the LN layer 616, first linear layer 608, activation function 610, and second linear layer 612 may operate in a substantially similar way as the LN layer 552, linear layer 554, activation function 556, and linear layer 558, respectively, of FIG. 5D. Parameters (e.g., weights) for the first linear layer 608, activation function 610, and second linear layer 612 may match (e.g., reused, shared, the same) for multiple feed-forward blocks configured to allow for parameter reuse. For example, the feed-forward block 604 and feed-forward block 606 may have the same weights for the first linear layer 608, activation function 610, and second linear layer 612. In some cases, parameters may be shared across blocks of a similar type (e.g., across multiple feed-forward blocks, or other ML networks or blocks which include a similar ML block architecture). Parameters of the LN layer 616 and adapter block 614 may vary between feed-forward blocks configured to allow parameter reuse.

In some cases, the adapter block 614 may generate an adaptive scaling weight that may be applied to intermediate features of a block (e.g., feed-forward block 604). In some cases, the adapter block 614 may leverage a low-rank bottleneck architecture so that the total number of parameters added by the adapter block 614 is relatively small compared to the parameters of, for example, the first linear layer 608, activation function 610, and second linear layer 612 of the feed-forward block 604. The bottleneck architecture for a ML block may, for example, reduce a number of dimensions in the input data, possibly apply a function to the reduced dimension data, and then expanded the dimensions again. An architecture for a ML block may be low-rank when the input vector dimension is smaller than the output vector dimension. Here, adapter block 614, includes a LN layer 622, which may normalize the data being input to the adapter block 614. The LN layer 622 may be followed by a first linear layer 624 which may reduce the dimensions of the input data. Output of the first linear layer 624 may be passed to an activation function 626. The activation function 626 may be a ReLU operation, GELU operation, or other non-linear function. Output of the activation function 626 may be passed to a second linear layer 628. The second linear layer 628 may expand the dimensions of the data. In some cases, data output by the second linear layer 628 may have more dimensions than the data input to the adapter block 614. The data output by the second linear layer 628 may be input into a sigmoid function 630. The sigmoid function 630 may convert the data to fit within a certain range, such as in a range from [0, 1]. The sigmoid function 630 may allow the adapter block 614 to operate as a dynamic masking function to vary the operation of different feed-forward blocks by adjusting the intermediate features of the feed-forward blocks. In some cases, the activation function 626 and sigmoid function 630 may be fixed functions (e.g., have the same weights/parameters) and remain the same as across instances of the adapter block 614 (e.g., between blocks, such as feed-forward blocks 604 and 606). Parameters of the LN layer 622, first linear layer 624, and second linear layer 628 may vary across instances of the adapter block 614. While adapter block 614 uses a bottleneck architecture that may be referred to as a multiplicative architecture, it should be understood that any architecture may be used. For example, any architecture that may be used to prompt-tune a pretrained LLM (e.g., append a tensor/prompt token) to fine-tune the pretrained LLM, may be used.

In some cases, the adapter block 614 may be trained as a part of training the overall ML model. For example, the adapter block 614 may be trained concurrently with the reused linear layers (e.g., first linear layer 608 and second linear layer 612) of the feed-forward blocks (e.g., feed-forward block 604, feed-forward block 606). Parameters of the adapter and rest of the feed-forward blocks may be initialized randomly and trained together. In some cases, no pre-training of certain blocks may be needed. During training, the parameters of the multiple feed-forward blocks sharing parameters are adjusted together. Training hyper-parameters may be used in a same manner as without reused parameters.

In some aspects, training of one or more of the machine learning systems or neural networks described herein (e.g., such as the neural network 200 of FIG. 2, the CNN 300 of FIG. 3, the deep convolutional network 450 of FIG. 4, the transformer block 500 of FIG. 5A, the conformer block 520 of FIG. 5B, the convnext block 540 of FIG. 5C, the feed-forward block 550 of FIG. 5D, the system 600 of FIG. 6, among various other machine learning networks described herein) can be performed using online training (e.g., in some case on-device training), offline training, and/or various combinations of online and offline training. In some cases, online may refer to time periods during which the input data (e.g., such as the input data 452 of FIG. 4, etc.) is processed, for instance for performing the techniques described herein by the systems described herein. In some examples, offline may refer to idle time periods or time periods during which input data is not being processed. Additionally, offline may be based on one or more time conditions (e.g., after a particular amount of time has expired, such as a day, a week, a month, etc.) and/or may be based on various other conditions such as network and/or server availability, etc., among various others. In some aspects, offline training of a machine learning model (e.g., a neural network model) can be performed by a first device (e.g., a server device) to generate a pre-trained model, and a second device can receive the trained model from the second device. In some cases, the second device (e.g., a mobile device, an XR device, a vehicle or system/component of the vehicle, or other device) can perform online (or on-device) training of the pre-trained model to further adapt or tune the parameters of the model.

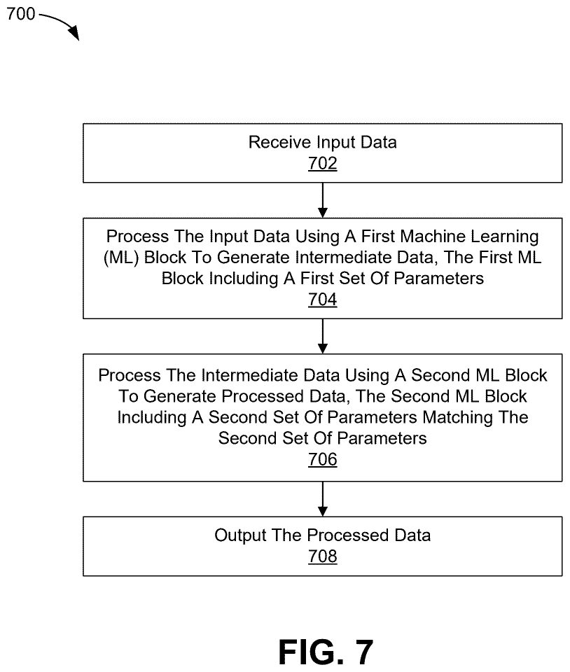

FIG. 7 is a flow diagram illustrating a process 700 for executing a machine learning model, in accordance with aspects of the present disclosure. The process 700 may be performed by a computing device (or apparatus) (e.g., SOC 100 of FIG. 1, computing device architecture 800 of FIG. 8) or a component (e.g., a chipset, codec, CPU 102, GPU 104, DSP 106, NPU 108 of FIG. 1, processor 810 of FIG. 8, etc.) of the computing device. The computing device may be a mobile device (e.g., a mobile phone), a network-connected wearable such as a watch, an extended reality (XR) device such as a virtual reality (VR) device or augmented reality (AR) device, a vehicle or component or system of a vehicle, or other type of computing device. The operations of the process 700 may be implemented as software components that are executed and run on one or more processors.

At block 702, the computing device (or component thereof) may receive input data. In some aspects, the input data includes image data. In cases, the input data includes data from a previous layer or block of a machine learning (ML) system. In some examples, the computing device can include one or more cameras configured to capture the image data.

At block 704, the computing device (or component thereof) may process the input data using a first ML block (e.g., feed-forward block 504, feed-forward block 522, feed-forward block 528, feed-forward block 544, feed-forward block 550 of FIGS. 5A-5D, feed-forward block 604, feed-forward block 606 of FIG. 6, etc.) to generate intermediate data. The first ML block includes a first set of parameters (e.g., parameters of linear layer 554, linear layer 558, of FIG. 5D, linear layer 608, linear layer 612 of FIG. 6, etc.). The first ML block can be part of the ML system.

At block 706, the computing device (or component thereof) may process the intermediate data using a second ML block (e.g., feed-forward block 504, feed-forward block 522, feed-forward block 528, feed-forward block 544, feed-forward block 550 of FIGS. 5A-5D, feed-forward block 604, feed-forward block 606 of FIG. 6, etc.) to generate processed data. The second ML block includes a second set of parameters matching the first set of parameters. For example, weights of some linear layers of a feed-forward block 604 may be the same as weights of corresponding linear layers of another feed-forward block 606. The second ML block can be part of the ML system.

In some cases, the intermediate data generated by the first ML block is processed by a third ML block (e.g., of the ML system) before being processed by the second ML block. For example, with a convnext block, the intermediate data may be processed by a self-attention block and a convolution block before being processed by the second ML block. As another example, for a transformer block, the intermediate data may be processed by a self-attention block of another transformer block, or multiple other block before being processed by the second ML block. In some examples, the first ML block and second ML block comprise a same type of ML block. In some cases, the first ML block and second ML block comprise a feed-forward block (e.g., feed-forward block (e.g., feed-forward block 504, feed-forward block 522, feed-forward block 528, feed-forward block 544, feed-forward block 550 of FIGS. 5A-5D, feed-forward block 604, feed-forward block 606 of FIG. 6, etc.). In some examples, the first set of parameters and second set of parameters comprise parameters for at least one linear layer (e.g., linear layer 608, linearly 612 of FIG. 6) of the feed-forward block. In some cases, the feed-forward block is a part of at least one of a transformer block (e.g., transformer block 500 of FIG. 5A), a conformer block (e.g., conformer block 520 of FIG. 5B), or a convnext block (e.g., convnext block 540 of FIG. 5C). In some examples, the feed-forward block includes an adapter block (e.g., adapter block 614 of FIG. 6). In some cases, the adapter block includes one or more linear layers (e.g., linear layer 624, linear layer 628 of FIG. 6). In some examples, parameters of the one or more linear layers of a first adapter block associated with the first ML block differ from parameters of the one or more linear layers of a second adapter block associated with the second ML block. In some cases, the adapter block further comprises a layer normalization layer (e.g., LN layer 622 of FIG. 6), an activation function (e.g., activation function 626 of FIG. 6), and a sigmoid function (e.g., sigmoid function 630 of FIG. 6). In some examples, the adapter block is trained with the first ML block and the second ML block. In some cases, the adapter block, the first ML block, and the second ML block are trained using on-device training.

At block 708, the computing device (or component thereof) may output the processed data.

In some examples, the techniques or processes described herein may be performed by a computing device, an apparatus, and/or any other computing device. In some cases, the computing device or apparatus may include a processor, microprocessor, microcomputer, or other component of a device that is configured to carry out the steps of processes described herein. In some examples, the computing device or apparatus may include a camera configured to capture video data (e.g., a video sequence) including video frames. For example, the computing device may include a camera device, which may or may not include a video codec. As another example, the computing device may include a mobile device with a camera (e.g., a camera device such as a digital camera, an IP camera or the like, a mobile phone or tablet including a camera, or other type of device with a camera). In some cases, the computing device may include a display for displaying images. In some examples, a camera or other capture device that captures the video data is separate from the computing device, in which case the computing device receives the captured video data. The computing device may further include a network interface, transceiver, and/or transmitter configured to communicate the video data. The network interface, transceiver, and/or transmitter may be configured to communicate Internet Protocol (IP) based data or other network data.

The processes described herein can be implemented in hardware, computer instructions, or a combination thereof. In the context of computer instructions, the operations represent computer-executable instructions stored on one or more computer-readable storage media that, when executed by one or more processors, perform the recited operations. Generally, computer-executable instructions include routines, programs, objects, components, data structures, and the like that perform particular functions or implement particular data types. The order in which the operations are described is not intended to be construed as a limitation, and any number of the described operations can be combined in any order and/or in parallel to implement the processes.

In some cases, the devices or apparatuses configured to perform the operations of the process 700 and/or other processes described herein may include a processor, microprocessor, micro-computer, or other component of a device that is configured to carry out the steps of the process 700 and/or other process. In some examples, such devices or apparatuses may include one or more sensors configured to capture image data and/or other sensor measurements. In some examples, such computing device or apparatus may include one or more sensors and/or a camera configured to capture one or more images or videos. In some cases, such device or apparatus may include a display for displaying images. In some examples, the one or more sensors and/or camera are separate from the device or apparatus, in which case the device or apparatus receives the sensed data. Such device or apparatus may further include a network interface configured to communicate data.

The components of the device or apparatus configured to carry out one or more operations of the process 700 and/or other processes described herein can be implemented in circuitry. For example, the components can include and/or can be implemented using electronic circuits or other electronic hardware, which can include one or more programmable electronic circuits (e.g., microprocessors, graphics processing units (GPUs), digital signal processors (DSPs), central processing units (CPUs), and/or other suitable electronic circuits), and/or can include and/or be implemented using computer software, firmware, or any combination thereof, to perform the various operations described herein. The computing device may further include a display (as an example of the output device or in addition to the output device), a network interface configured to communicate and/or receive the data, any combination thereof, and/or other component(s). The network interface may be configured to communicate and/or receive Internet Protocol (IP) based data or other type of data.

The process 700 is illustrated as a logical flow diagram, the operations of which represent sequences of operations that can be implemented in hardware, computer instructions, or a combination thereof. In the context of computer instructions, the operations represent computer-executable instructions stored on one or more computer-readable storage media that, when executed by one or more processors, perform the recited operations. Generally, computer-executable instructions include routines, programs, objects, components, data structures, and the like that perform particular functions or implement particular data types. The order in which the operations are described is not intended to be construed as a limitation, and any number of the described operations can be combined in any order and/or in parallel to implement the processes.

Additionally, the processes described herein (e.g., the process 700 and/or other processes) may be performed under the control of one or more computer systems configured with executable instructions and may be implemented as code (e.g., executable instructions, one or more computer programs, or one or more applications) executing collectively on one or more processors, by hardware, or combinations thereof. As noted above, the code may be stored on a computer-readable or machine-readable storage medium, for example, in the form of a computer program including a plurality of instructions executable by one or more processors. The computer-readable or machine-readable storage medium may be non-transitory.

Additionally, the processes described herein may be performed under the control of one or more computer systems configured with executable instructions and may be implemented as code (e.g., executable instructions, one or more computer programs, or one or more applications) executing collectively on one or more processors, by hardware, or combinations thereof. As noted above, the code may be stored on a computer-readable or machine-readable storage medium, for example, in the form of a computer program comprising a plurality of instructions executable by one or more processors. The computer-readable or machine-readable storage medium may be non-transitory.

FIG. 8 illustrates an example computing device architecture 800 of an example computing device which can implement the various techniques described herein. In some examples, the computing device can include a mobile device, a wearable device, an extended reality device (e.g., a virtual reality (VR) device, an augmented reality (AR) device, or a mixed reality (MR) device), a personal computer, a laptop computer, a video server, a vehicle (or computing device of a vehicle), or other device. The components of computing device architecture 800 are shown in electrical communication with each other using connection 805, such as a bus. The example computing device architecture 800 includes a processing unit (CPU or processor) 810 and computing device connection 805 that couples various computing device components including computing device memory 815, such as read only memory (ROM) 820 and random access memory (RAM) 825, to processor 810.

Computing device architecture 800 can include a cache of high-speed memory connected directly with, in close proximity to, or integrated as part of processor 810. Computing device architecture 800 can copy data from memory 815 and/or the storage device 830 to cache 812 for quick access by processor 810. In this way, the cache can provide a performance boost that avoids processor 810 delays while waiting for data. These and other modules can control or be configured to control processor 810 to perform various actions. Other computing device memory 815 may be available for use as well. Memory 815 can include multiple different types of memory with different performance characteristics. Processor 810 can include any general purpose processor and a hardware or software service, such as service 1 832, service 2 834, and service 3 836 stored in storage device 830, configured to control processor 810 as well as a special-purpose processor where software instructions are incorporated into the processor design. Processor 810 may be a self-contained system, containing multiple cores or processors, a bus, memory controller, cache, etc. A multi-core processor may be symmetric or asymmetric.

To enable user interaction with the computing device architecture 800, input device 845 can represent any number of input mechanisms, such as a microphone for speech, a touch-sensitive screen for gesture or graphical input, keyboard, mouse, motion input, speech and so forth. Output device 835 can also be one or more of a number of output mechanisms known to those of skill in the art, such as a display, projector, television, speaker device, etc. In some instances, multimodal computing devices can enable a user to provide multiple types of input to communicate with computing device architecture 800. Communication interface 840 can generally govern and manage the user input and computing device output. There is no restriction on operating on any particular hardware arrangement and therefore the basic features here may easily be substituted for improved hardware or firmware arrangements as they are developed.

Storage device 830 is a non-volatile memory and can be a hard disk or other types of computer readable media which can store data that are accessible by a computer, such as magnetic cassettes, flash memory cards, solid state memory devices, digital versatile disks, cartridges, random access memories (RAMs) 825, read only memory (ROM) 820, and hybrids thereof. Storage device 830 can include services 832, 834, 836 for controlling processor 810. Other hardware or software modules are contemplated. Storage device 830 can be connected to the computing device connection 805. In one aspect, a hardware module that performs a particular function can include the software component stored in a computer-readable medium in connection with the necessary hardware components, such as processor 810, connection 805, output device 835, and so forth, to carry out the function.

Aspects of the present disclosure are applicable to any suitable electronic device (such as security systems, smartphones, tablets, laptop computers, vehicles, drones, or other devices) including or coupled to one or more active depth sensing systems. While described below with respect to a device having or coupled to one light projector, aspects of the present disclosure are applicable to devices having any number of light projectors, and are therefore not limited to specific devices.

The term “device” is not limited to one or a specific number of physical objects (such as one smartphone, one controller, one processing system and so on). As used herein, a device may be any electronic device with one or more parts that may implement at least some portions of this disclosure. While the below description and examples use the term “device” to describe various aspects of this disclosure, the term “device” is not limited to a specific configuration, type, or number of objects. Additionally, the term “system” is not limited to multiple components or specific embodiments. For example, a system may be implemented on one or more printed circuit boards or other substrates, and may have movable or static components. While the below description and examples use the term “system” to describe various aspects of this disclosure, the term “system” is not limited to a specific configuration, type, or number of objects.

Specific details are provided in the description above to provide a thorough understanding of the embodiments and examples provided herein. However, it will be understood by one of ordinary skill in the art that the embodiments may be practiced without these specific details. For clarity of explanation, in some instances the present technology may be presented as including individual functional blocks including functional blocks comprising devices, device components, steps or routines in a method embodied in software, or combinations of hardware and software. Additional components may be used other than those shown in the figures and/or described herein. For example, circuits, systems, networks, processes, and other components may be shown as components in block diagram form in order not to obscure the embodiments in unnecessary detail. In other instances, well-known circuits, processes, algorithms, structures, and techniques may be shown without unnecessary detail in order to avoid obscuring the embodiments.

Individual embodiments may be described above as a process or method which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed but could have additional steps not included in a figure. A process may correspond to a method, a function, a procedure, a subroutine, a subprogram, etc. When a process corresponds to a function, its termination can correspond to a return of the function to the calling function or the main function.

Processes and methods according to the above-described examples can be implemented using computer-executable instructions that are stored or otherwise available from computer-readable media. Such instructions can include, for example, instructions and data which cause or otherwise configure a general-purpose computer, special purpose computer, or a processing device to perform a certain function or group of functions. Portions of computer resources used can be accessible over a network. The computer executable instructions may be, for example, binaries, intermediate format instructions such as assembly language, firmware, source code, etc.

The term “computer-readable medium” includes, but is not limited to, portable or non-portable storage devices, optical storage devices, and various other mediums capable of storing, containing, or carrying instruction(s) and/or data. A computer-readable medium may include a non-transitory medium in which data can be stored and that does not include carrier waves and/or transitory electronic signals propagating wirelessly or over wired connections. Examples of a non-transitory medium may include, but are not limited to, a magnetic disk or tape, optical storage media such as flash memory, memory or memory devices, magnetic or optical disks, flash memory, USB devices provided with non-volatile memory, networked storage devices, compact disk (CD) or digital versatile disk (DVD), any suitable combination thereof, among others. A computer-readable medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc., may be passed, forwarded, or transmitted via any suitable means including memory sharing, message passing, token passing, network transmission, or the like.

In some embodiments, the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Devices implementing processes and methods according to these disclosures can include hardware, software, firmware, middleware, microcode, hardware description languages, or any combination thereof, and can take any of a variety of form factors. When implemented in software, firmware, middleware, or microcode, the program code or code segments to perform the necessary tasks (e.g., a computer-program product) may be stored in a computer-readable or machine-readable medium. A processor(s) may perform the necessary tasks. Typical examples of form factors include laptops, smart phones, mobile phones, tablet devices or other small form factor personal computers, personal digital assistants, rackmount devices, standalone devices, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are example means for providing the functions described in the disclosure.

In the foregoing description, aspects of the application are described with reference to specific embodiments thereof, but those skilled in the art will recognize that the application is not limited thereto. Thus, while illustrative embodiments of the application have been described in detail herein, it is to be understood that the inventive concepts may be otherwise variously embodied and employed, and that the appended claims are intended to be construed to include such variations, except as limited by the prior art. Various features and aspects of the above-described application may be used individually or jointly. Further, embodiments can be utilized in any number of environments and applications beyond those described herein without departing from the broader spirit and scope of the specification. The specification and drawings are, accordingly, to be regarded as illustrative rather than restrictive. For the purposes of illustration, methods were described in a particular order. It should be appreciated that in alternate embodiments, the methods may be performed in a different order than that described.

One of ordinary skill will appreciate that the less than (“<”) and greater than (“>”) symbols or terminology used herein can be replaced with less than or equal to (“≤”) and greater than or equal to (“≥”) symbols, respectively, without departing from the scope of this description.

Where components are described as being “configured to” perform certain operations, such configuration can be accomplished, for example, by designing electronic circuits or other hardware to perform the operation, by programming programmable electronic circuits (e.g., microprocessors or other suitable electronic circuits) to perform the operation, or any combination thereof.

The phrase “coupled to” refers to any component that is physically connected to another component either directly or indirectly and/or any component that is in communication with another component (e.g., connected to the other component over a wired or wireless connection, and/or other suitable communication interface) either directly or indirectly.

Claim language or other language reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, A and B and C, or any duplicate information or data (e.g., A and A, B and B, C and C, A and A and B, and so on), or any other ordering, duplication, or combination of A, B, and C. The language “at least one of” a set and/or “one or more” of a set does not limit the set to the items listed in the set. For example, claim language reciting “at least one of A and B” or “at least one of A or B” may mean A, B, or A and B, and may additionally include items not listed in the set of A and B. The phrases “at least one” and “one or more” are used interchangeably herein.

Claim language or other language reciting “at least one processor configured to,” “at least one processor being configured to,” “one or more processors configured to,” “one or more processors being configured to,” or the like indicates that one processor or multiple processors (in any combination) can perform the associated operation(s). For example, claim language reciting “at least one processor configured to: X, Y, and Z” means a single processor can be used to perform operations X, Y, and Z; or that multiple processors are each tasked with a certain subset of operations X, Y, and Z such that together the multiple processors perform X, Y, and Z; or that a group of multiple processors work together to perform operations X, Y, and Z. In another example, claim language reciting “at least one processor configured to: X, Y, and Z” can mean that any single processor may only perform at least a subset of operations X, Y, and Z.

Where reference is made to one or more elements performing functions (e.g., steps of a method), one element may perform all functions, or more than one element may collectively perform the functions. When more than one element collectively performs the functions, each function need not be performed by each of those elements (e.g., different functions may be performed by different elements) and/or each function need not be performed in whole by only one element (e.g., different elements may perform different sub-functions of a function). Similarly, where reference is made to one or more elements configured to cause another element (e.g., an apparatus) to perform functions, one element may be configured to cause the other element to perform all functions, or more than one element may collectively be configured to cause the other element to perform the functions.

Where reference is made to an entity (e.g., any entity or device described herein) performing functions or being configured to perform functions (e.g., steps of a method), the entity may be configured to cause one or more elements (individually or collectively) to perform the functions. The one or more components of the entity may include at least one memory, at least one processor, at least one communication interface, another component configured to perform one or more (or all) of the functions, and/or any combination thereof. Where reference to the entity performing functions, the entity may be configured to cause one component to perform all functions, or to cause more than one component to collectively perform the functions. When the entity is configured to cause more than one component to collectively perform the functions, each function need not be performed by each of those components (e.g., different functions may be performed by different components) and/or each function need not be performed in whole by only one component (e.g., different components may perform different sub-functions of a function).

The various illustrative logical blocks, modules, circuits, and algorithm steps described in connection with the embodiments disclosed herein may be implemented as electronic hardware, computer software, firmware, or combinations thereof. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present application.

The techniques described herein may also be implemented in electronic hardware, computer software, firmware, or any combination thereof. Such techniques may be implemented in any of a variety of devices such as general purposes computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium comprising program code including instructions that, when executed, performs one or more of the methods described above. The computer-readable data storage medium may form part of a computer program product, which may include packaging materials. The computer-readable medium may comprise memory or data storage media, such as random access memory (RAM) such as synchronous dynamic random access memory (SDRAM), read-only memory (ROM), non-volatile random access memory (NVRAM), electrically erasable programmable read-only memory (EEPROM), FLASH memory, magnetic or optical data storage media, and the like. The techniques additionally, or alternatively, may be realized at least in part by a computer-readable communication medium that carries or communicates program code in the form of instructions or data structures and that can be accessed, read, and/or executed by a computer, such as propagated signals or waves.

The program code may be executed by a processor, which may include one or more processors, such as one or more digital signal processors (DSPs), general purpose microprocessors, an application specific integrated circuits (ASICs), field programmable logic arrays (FPGAs), or other equivalent integrated or discrete logic circuitry. Such a processor may be configured to perform any of the techniques described in this disclosure. A general purpose processor may be a microprocessor; but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein.

Illustrative aspects of the disclosure include:

Aspect 1. An apparatus for executing a machine learning model, comprising: one or more memories; and one or more processors coupled to the one or more memories and configured to: receive input data; process the input data using a first machine learning (ML) block to generate intermediate data, the first ML block including a first set of parameters; process the intermediate data using a second ML block to generate processed data, the second ML block including a second set of parameters matching the first set of parameters; and output the processed data.

Aspect 2. The apparatus of Aspect 1, wherein the intermediate data generated by the first ML block is processed by a third ML block before being processed by the second ML block.

Aspect 3. The apparatus of Aspect 1, wherein the first ML block and second ML block comprise a same type of ML block.

Aspect 4. The apparatus of Aspect 3, wherein the first ML block and second ML block comprise a feed-forward block.

Aspect 5. The apparatus of Aspect 4, wherein the first set of parameters and second set of parameters comprise parameters for at least one linear layer of the feed-forward block.

Aspect 6. The apparatus of any of Aspects 4-5, wherein the feed-forward block is a part of at least one of a transformer block, a conformer block, or a convnext block.

Aspect 7. The apparatus of any of Aspects 4-6, wherein the feed-forward block includes an adapter block.

Aspect 8. The apparatus of Aspect 7, wherein the adapter block includes one or more linear layers.

Aspect 9. The apparatus of Aspect 8, wherein parameters of the one or more linear layers of a first adapter block associated with the first ML block differ from parameters of the one or more linear layers of a second adapter block associated with the second ML block.

Aspect 10. The apparatus of any of Aspects 8-9, wherein the adapter block further comprises a layer normalization layer, an activation function, and a sigmoid function.

Aspect 11. The apparatus of any of Aspects 7-10, wherein the adapter block is trained with the first ML block and the second ML block.

Aspect 12. The apparatus of any of Aspects 7-11, wherein the adapter block, the first ML block, and the second ML block are trained using on-device training.

Aspect 13. The apparatus of any of Aspects 1-12, wherein the input data comprises image data.

Aspect 14. The apparatus of Aspect 13, further comprising one or more cameras configured to capture the image data.

Aspect 15. A method for executing a machine learning model, comprising: receiving input data; processing the input data using a first machine learning (ML) block to generate intermediate data, the first ML block including a first set of parameters; processing the intermediate data using a second ML block to generate processed data, the second ML block including a second set of parameters matching the first set of parameters; and outputting the processed data.

Aspect 16. The method of Aspect 15, wherein the intermediate data generated by the first ML block is processed by a third ML block before being processed by the second ML block.

Aspect 17. The method of any of Aspects 15-16, wherein the first ML block and second ML block comprise a same type of ML block.

Aspect 18. The method of Aspect 17, wherein the first ML block and second ML block comprise a feed-forward block.

Aspect 19. The method of Aspect 18, wherein the first set of parameters and second set of parameters comprise parameters for at least one linear layer of the feed-forward block.

Aspect 20. The method of any of Aspects 18-19, wherein the feed-forward block is a part of at least one of a transformer block, a conformer block, or a convnext block.

Aspect 21. The method of any of Aspects 18-20, wherein the feed-forward block includes an adapter block.

Aspect 22. The method of Aspect 21, wherein the adapter block includes one or more linear layers.

Aspect 23. The method of Aspect 22, wherein parameters of the one or more linear layers of a first adapter block associated with the first ML block differ from parameters of the one or more linear layers of a second adapter block associated with the second ML block.

Aspect 24. The method of any of Aspects 22-23, wherein the adapter block further comprises a layer normalization layer, an activation function, and a sigmoid function.

Aspect 25. The method of any of Aspects 21-24, wherein the adapter block is trained with the first ML block and the second ML block.

Aspect 26. The method of any of Aspects 21-25, wherein the adapter block, the first ML block, and the second ML block are trained using on-device training.

Aspect 27. A non-transitory computer-readable medium having stored thereon instructions that, when executed by at least one processor, cause the at least one processor to: receive input data; process the input data using a first machine learning (ML) block to generate intermediate data, the first ML block including a first set of parameters; process the intermediate data using a second ML block to generate processed data, the second ML block including a second set of parameters matching the first set of parameters; and output the processed data.

Aspect 28. The non-transitory computer-readable medium of Aspect 27, wherein the intermediate data generated by the first ML block is processed by a third ML block before being processed by the second ML block.

Aspect 29. The non-transitory computer-readable medium of any of Aspects 27-28, wherein the first ML block and second ML block comprise a same type of ML block.

Aspect 30. The non-transitory computer-readable medium of Aspect 29, wherein the first ML block and second ML block comprise a feed-forward block.

Aspect 31. The non-transitory computer-readable medium of Aspect 30, wherein the first set of parameters and second set of parameters comprise parameters for at least one linear layer of the feed-forward block.

Aspect 32. The non-transitory computer-readable medium of any of Aspects 30-31, wherein the feed-forward block is a part of at least one of a transformer block, a conformer block, or a convnext block.

Aspect 33. The non-transitory computer-readable medium of any of Aspects 28-30, wherein the feed-forward block includes an adapter block.

Aspect 34. The non-transitory computer-readable medium of Aspect 33, wherein the adapter block includes one or more linear layers.

Aspect 35. The non-transitory computer-readable medium of Aspect 34, wherein parameters of the one or more linear layers of a first adapter block associated with the first ML block differ from parameters of the one or more linear layers of a second adapter block associated with the second ML block.

Aspect 36. The non-transitory computer-readable medium of any of Aspects 34-35, wherein the adapter block further comprises a layer normalization layer, an activation function, and a sigmoid function.

Aspect 37. The non-transitory computer-readable medium of any of Aspects 33-36, wherein the adapter block is trained with the first ML block and the second ML block.

Aspect 38. The non-transitory computer-readable medium of any of Aspects 33-37, wherein the adapter block, the first ML block, and the second ML block are trained using on-device training.

Aspect 39: An apparatus comprising one or more means for performing operations according to any one or more of Aspects 15-26.

What is claimed is:

1. An apparatus for executing a machine learning model, comprising:
one or more memories; and
one or more processors coupled to the one or more memories and configured to:
receive input data;
process the input data using a first machine learning (ML) block to generate intermediate data, the first ML block including a first set of parameters;
process the intermediate data using a second ML block to generate processed data, the second ML block including a second set of parameters matching the first set of parameters; and
output the processed data.

2. The apparatus of claim 1, wherein the intermediate data generated by the first ML block is processed by a third ML block before being processed by the second ML block.

3. The apparatus of claim 1, wherein the first ML block and second ML block comprise a same type of ML block.

4. The apparatus of claim 3, wherein the first ML block and second ML block comprise a feed-forward block.

5. The apparatus of claim 4, wherein the first set of parameters and second set of parameters comprise parameters for at least one linear layer of the feed-forward block.

6. The apparatus of claim 4, wherein the feed-forward block is a part of at least one of a transformer block, a conformer block, or a convnext block.

7. The apparatus of claim 4, wherein the feed-forward block includes an adapter block.

8. The apparatus of claim 7, wherein the adapter block includes one or more linear layers.

9. The apparatus of claim 8, wherein parameters of the one or more linear layers of a first adapter block associated with the first ML block differ from parameters of the one or more linear layers of a second adapter block associated with the second ML block.

10. The apparatus of claim 8, wherein the adapter block further comprises a layer normalization layer, an activation function, and a sigmoid function.

11. The apparatus of claim 7, wherein the adapter block is trained with the first ML block and the second ML block.

12. The apparatus of claim 7, wherein the adapter block, the first ML block, and the second ML block are trained using on-device training.

13. The apparatus of claim 1, wherein the input data comprises image data.

14. The apparatus of claim 13, further comprising one or more cameras configured to capture the image data.

15. A method for executing a machine learning model, comprising:
receiving input data;
processing the input data using a first machine learning (ML) block to generate intermediate data, the first ML block including a first set of parameters;
processing the intermediate data using a second ML block to generate processed data, the second ML block including a second set of parameters matching the first set of parameters; and
outputting the processed data.

16. The method of claim 15, wherein the intermediate data generated by the first ML block is processed by a third ML block before being processed by the second ML block.

17. The method of claim 15, wherein the first ML block and second ML block comprise a same type of ML block.

18. The method of claim 17, wherein the first ML block and second ML block comprise a feed-forward block.

19. The method of claim 18, wherein the first set of parameters and second set of parameters comprise parameters for at least one linear layer of the feed-forward block.

20. The method of claim 18, wherein the feed-forward block is a part of at least one of a transformer block, a conformer block, or a convnext block.
